(19) United States
(12) Patent Application Publication
(10) Pub. No.: US 2009/0280810 A1
(43) Pub. Date: Nov. 12, 2009

(54) METHOD FOR TRANSITIONING SUPPORT OF COMMUNICATION SESSIONS FOR A USER ELEMENT BETWEEN DIFFERENT TYPES OF SUBSYSTEMS OF DIFFERENT GENERATIONS

(75) Inventors: Kaniz Mahdi, Carrollton, TX (US); Saso Stojanovski, Paris (FR)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent, PQ (CA)

(21) Appl. No.: 12/304,458

(22) PCT Filed: Jun. 8, 2007
(86) PCT No.: PCT/IB07/01555

§ 371 Date: Dec. 11, 2008

(51) Int. Cl. H04W 36/00

(52) U.S. Cl. 455/436

(57) ABSTRACT

The present invention provides a method for transitioning a local access leg of a communication session for a user element from a serving access network of one generation to a target access network of another generation, where one access network is in a circuit-switched subsystem domain and the other is in a packet subsystem domain. To transition the local access leg for the user element between the first access network and the second access network, a transitional cell is employed. The local access leg is first transferred to a transitional cell from a serving cell of the serving access network, and is then immediately transferred to a target cell of the target access network, while maintaining continuity of the communication session across both transfers. Maintaining continuity of the communication session means that there is no interruption in the communication session during the transitions.

This application claims the benefit of U.S. provisional patent application Ser. No. 60/813,492 filed Jun. 14, 2006, the disclosure of which is incorporated herein by reference in its entirety.

### FIELD OF THE INVENTION

The present invention relates to cellular communications, and in particular to facilitating transitions between cells of different generations and residing in different types of subsystems.

### BACKGROUND OF THE INVENTION

Wireless communications technology is rapidly evolving to address the ever-increasing need for additional bandwidth and services. With each generation of wireless communication standards, the available bandwidth and services that are made available to subscribers have dramatically increased. Unfortunately, each generation of wireless communication standards generally requires additional network infrastructure and compatible user elements. In many instances, the network infrastructure of a new generation does not support that of an earlier generation. Further, different networks and generations thereof handle voice and data in different ways. For example, second generation (2G) networks rely heavily on circuit-switched communications for voice and data, while many third generation (3G) networks provide circuit-switched subsystems as well as packet-based subsystems for voice and data, respectively. Upcoming fourth generation (4G) networks may use packet-based subsystems for voice and data with little or no reliance on a circuit-switched subsystem. As one can imagine, transitioning from a packet subsystem of one generation to a circuit-switched subsystem of another generation, and vice versa, has proven to be cumbersome. Further, current techniques that provide such transitions result in an interruption of the bearer path for the communication session.

Accordingly, there is a need for technique to efficiently and effectively transition support of communication sessions for a user element between different types of subsystems of different generations without interrupting the communication session.

### SUMMARY OF THE INVENTION

The present invention provides a method for transitioning a local access leg of a communication session for a user element from a serving access network of one generation to a target access network of another generation, where one access network is in a circuit-switched subsystem (CS) domain and the other is in a packet subsystem (PS) domain. To transition the local access leg for the user element between the first access network and the second access network, a transitional cell is employed. The local access leg is first transferred to a transitional cell from a serving cell of the serving access network, and is then immediately transferred to a target cell of the target access network, while maintaining continuity of the communication session across both transfers. Maintaining continuity of the communication session means that there is no interruption in the communication session during the transitions.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIGS. 1-3 illustrate a transition from a serving cell to a target cell through a transitional cell according to a first embodiment of the present invention.

FIGS. 4 and 5 illustrate a transition from a serving cell to a target cell through a transitional cell according to a second embodiment of the present invention.

FIGS. 6-8 illustrate a transition from a serving cell to a target cell through a transitional cell according to a third embodiment of the present invention.

FIGS. 9 and 10 illustrate a transition from a serving cell to a target cell through a transitional cell according to a fourth embodiment of the present invention.

FIG. 11 is a block representation of a service node according to one embodiment of the present invention.

FIG. 12 is a block representation of a user element according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides a method for transitioning a local access leg of a communication session for a user element from a serving access network of one generation to a target access network of another generation, where one access network is in a circuit-switched subsystem (CS) domain and the other is in a packet subsystem (PS) domain. To transition the local access leg for the user element between the first access network and the second access network, a transitional cell is employed. The local access leg is first transferred to a transitional cell from a serving cell of the serving access network, and is then immediately transferred to a target cell of the target access network, while maintaining continuity of the communication session across both transfers. Maintaining continuity of the communication session means that there is no interruption in the communication session during the transitions.

The local access leg may include a signaling leg and a bearer leg for the overall signaling path and bearer path, respectively, for the communication session. The CS domain supports circuit-switched communications via a circuit-switched bearer path, while the PS domain supports packet-based communications via a packet bear path. Further, each CS or PS may support multiple generations. Each generation is an evolutionary generation of wireless communication infrastructures and communication standards. Second generation (2G), third generation (3G), and fourth generation (4G) communication systems are referenced herein. 2G standards are digital in nature and rely primarily on a CS domain for voice and data. Select 2G systems include but are not limited to Global System for Mobile Communications (GSM), Digital Advanced Mobile Phone System (D-AMPS), Interim Standard 95 (IS-95) (Code Division Multiple Access—CDMA), General Packet Radio Service (GPRS), and CDMA2000 (1xRTT/IS-2000). 3G standards are digital in nature and employ a PS domain in parallel with a CS domain to provided increased data rates over 2G systems. Select 3G systems include but are not limited to Enhanced Data Rates for GSM Evolution (EDGE), Enhanced GPRS (EGPRS), Wideband CDMA (W-CDMA), and Universal Mobile Telecommunications System (UMTS) (Third Generation GSM-3GSM), 1x Evolution-Data Only (1xEV-DO)/IS-856, and Time Division-Synchronous Code Division Multiple Access (TD-SCDMA). 4G standards are digital in nature and will generally rely on a PS domain for voice and data. In most systems, no CS domain is necessary. 4G systems include, but are not limited to Worldwide Interoperability for Microwave Access (WiMax), Wireless Metropolitan Area Network (WirelessMAN), IEEE802.16, and the proposed Third Generation Partnership Project (3GPP) Long Term Evolution work-in-progress technologies, such as enhanced UMTS and W-CDMA.

In one embodiment, the transitional cell resides in the same domain as the serving cell and is of the same generation as the target cell. As such, the first local access leg transfer changes generations within the same domain, while the second local access leg transfer changes domains within the same generation. In another embodiment, the transitional cell resides in the same domain as the target cell and is of the same generation as the serving cell. As such, the first local access leg transfer changes domains within the same generation, while the second local access leg transfer changes generations with the same domain. The serving, transitional, and target access cells are logical in nature and may be supported by common infrastructure with the same or different access networks. For example, architecture of one generation may support CS and PS domains, while architecture of a given domain may support different generations.

In one embodiment, one local access leg transfer among the serving, transitional, and target cells is a radio layer handover, while the other local access leg transfer is an application layer handover. Radio layer handovers are primarily controlled by the access network at a radio link layer within a given CS or PS domain in association with the user element. Radio layer handovers may transition local access legs directly between cells of a given generation or between cells of different generations, as long as the cells are within a given domain. Generally, radio layer handovers are not available for local access leg transfers between a cell in a CS domain and a cell in a PS domain. Application layer handovers are primarily controlled by a session control application residing in a multimedia subsystem (MS) at an application layer in association with the user element. Application layer handovers may transition the local access legs from a domain of one type (CS or PS) to a domain of another type (CS or PS).

An exemplary MS is the Internet Protocol (IP) Multimedia Subsystem (IMS), as set forth by the Third Generation Partnership Project (3GPP). An MS may reside on or in the PS domain and at least be accessible by the PS and the CS for session control. In certain embodiments, a continuity control function (CCF) in the MS is provided as a session control application, which is accessible by a call/session control function (CSCF). Call control for originating and terminating calls in the CS or PS domains as well as transferring calls between the PS and CS domains may be anchored at the CCF in the MS. All call signaling for the call is passed through the CCF. The CCF is a service provided in an associated MS, and anchors the user element's active communication sessions to enable control and facilitate mobility across the CS and PS domains while maintaining session continuity. Session signaling between the user element and the remote party is broken into two legs, the local access leg and a remote access leg. The local access leg extends through the PS or CS domains serving the user element to the CCF via the CSCF. The remote access leg extends from the CCF toward the remote party via the CSCF.

In one embodiment, the CCF employs a Third Party Call Control function to control elements in the CS domain to provide session control within the CS domain. The CCF may also provide session control in the PS domain by interacting with the user element and the remote party to establish and control a bearer path between the user element and the remote endpoint. Accordingly, the CCF may play an active role in for transitions from the serving cell to the target cell through a transitional cell. The remote access leg will remain in place between the CCF and the remote party, while the local access leg is transferred from the serving cell to the target cell through the transitional cell. Notably, one end of the local access leg will remain anchored at the CCF, although the corresponding portions of signaling and bearer paths will change.

The CCF may be addressable using public service identities (PSI) from the CS or PS domains. In the CS domain, a directory number associated with the CCF is used for routing call signaling messages within the CS. In the PS domain or in the MS itself, a uniform resource locator (URL) associated with the CCF may used for routing call signaling messages. In the following description, 3GPP TS 24.008 (DTAP) is used in the CS, while the Session Initiation Protocol (SIP) is used in the PS domain and MS to effect origination, termination, and transfer of communication sessions, including calls. Those skilled in the art will recognize other applicable and useful protocols as substitutes for DTAP and SIP. For additional information relating to call continuity, reference is made to U.S. patent application Ser. No. 11/378,776 filed Mar. 17, 2006; U.S. patent application Ser. No. 11/440,165 filed May 24, 2006; U.S. patent application Ser. No. 11/452,069 filed Jun. 12, 2006; U.S. patent application Ser. No. 11/451,722 filed Jun. 13, 2006; U.S. patent application Ser. No. 11/466,115 filed Aug. 22, 2006; and U.S. patent application Ser. No. 11/554,930 filed Oct. 31, 2006; and International Application serial number ______ entitled INTER-SUBSYSTEM TRANSFERS and filed concurrently herewith, which are incorporated herein by reference in their entireties.

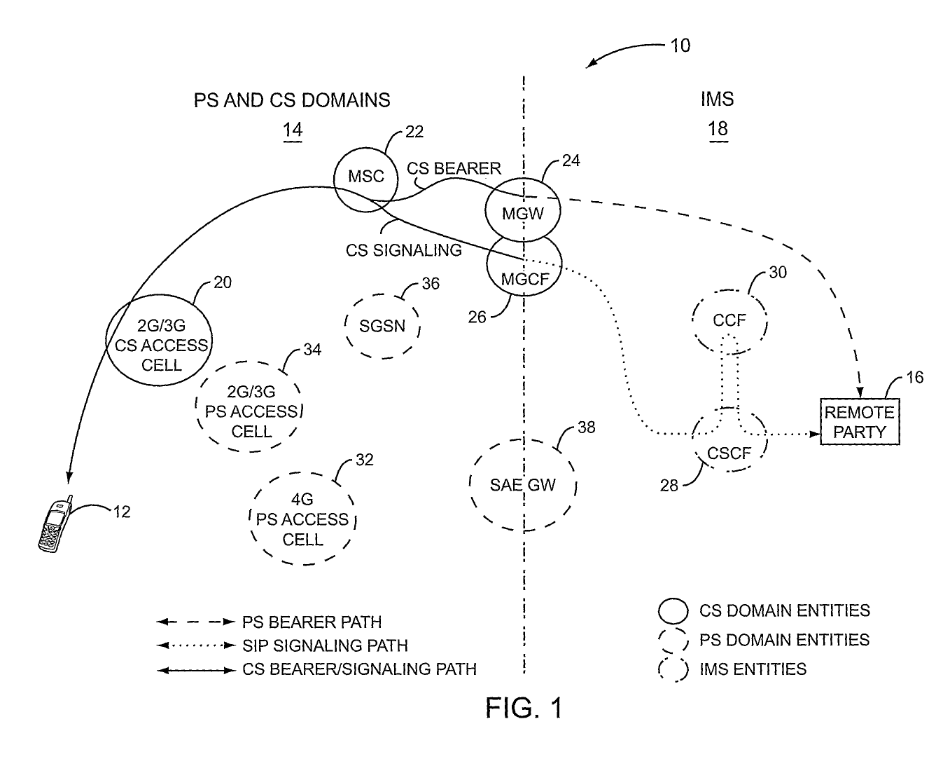

With reference to FIG. 1, an exemplary communication environment 10 is provided wherein a user element 12 is served by PS and CS domains 14. As illustrated, the user element 12 is engaged in a communication session with a remote party 16, and at least part of the session control for the communication session is provided by an IMS 18. The CS bearer and signaling paths for the local access leg initially run from the user element 12 through a 2G or 3G (2G/3G) CS access cell 20 of a CS access network and on to an associated mobile switching center (MSC) 22, which may be associated with a visiting location register (VLR) in traditional fashion. The CS bearer path and the CS signaling path of the local access leg may be split at the MSC 22, wherein the CS bearer path is sent to a media gateway (MGW) 24, which is associated with a media gateway control function (MGCF) 26. The media gateway 24 will provide the necessary translation between circuit-switched communications in the CS bearer path and packet-based communications for a PS bearer path that extends to the remote party 16. The media gateway 24 allows bidirectional communications between the user element 12 and the remote party 16.

The media gateway 24 is controlled by the MGCF 26, which is a session or call signaling entity that facilitates interaction between the CS portion of the PS and CS domains 14 and the IMS 18. As such, the CS signaling path extends from the MSC 22 to the MGCF 26, and into the IMS 18. In particular, the CS signaling portion of the local access leg extends to a CSCF 28, and then on to a CCF 30. As noted above, the CCF 30 may provide an anchor point for session control and signaling, and may define an endpoint for the local access signaling leg and the remote access signaling leg. The CCF 30 facilitates signaling between these signaling legs. As such, the remote access signaling leg extends from the CCF 30 to the remote party 16 through the CSCF 28. The local access signaling leg will extend from the CCF 30 to the user element 12 via the CSCF 28, MGCF 26, MSC 22, the 2G/3G CS access cell 20, and the like. In this embodiment, SIP signaling may be used between the MGCF 26 and the remote party 16, while traditional CS signaling is used between the MGCF 26 and the 2G/3G CS access cell 20 or user element 12.

In this embodiment, assume the user element 12, CCF 30, or other appropriate entity determines a need to transition the user element 12 from being served by the 2G/3G CS access cell 20 to being served by a 4G PS access cell 32. As such, the 2G/3G CS access cell 20 is the serving cell, and the 4G PS access cell 32 is the target cell. To efficiently transition from the 2G/3G CS access cell 20 to the 4G PS access cell 32 in a manner maintaining continuity of the communication session, a 2G/3G PS access cell 34 is employed as a transitional cell. Accordingly, the local access leg for the user element 12 is first transitioned to the 2G/3G PS access cell 34 to change from the CS domain to the PS domain, and is then transitioned to the 4G PS access cell 32 to change from the second or third generation cell to a fourth generation cell.

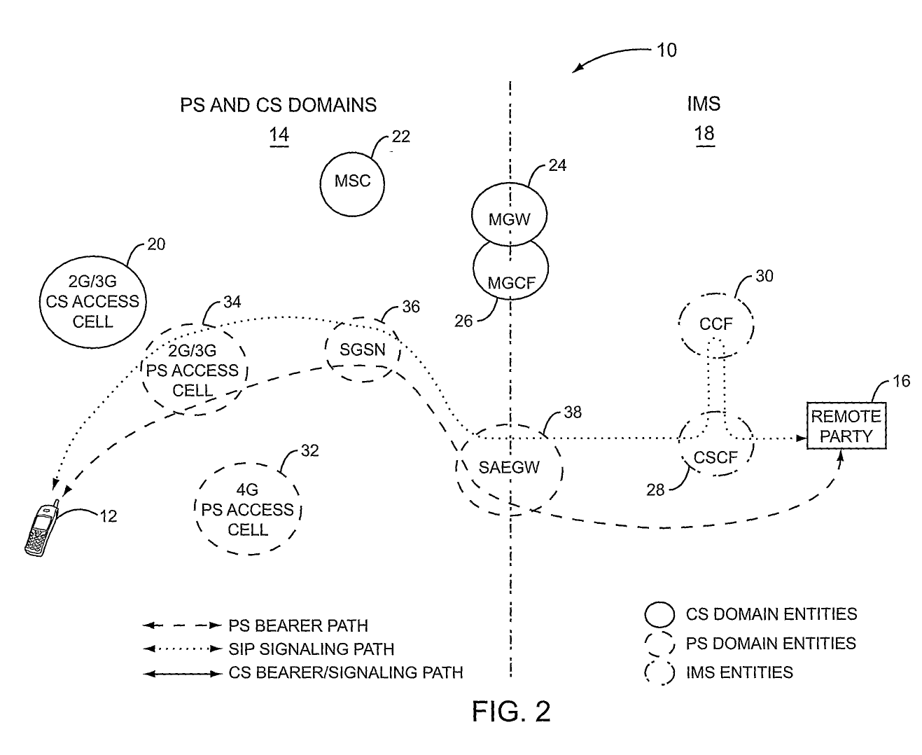

FIG. 2 illustrates the signaling and bearer paths for the communication session after a transition to the 2G/3G PS access cell 34. Since the 2G/3G PS access cell 34 facilitates packet-based signaling and bearer paths, packet entities are employed between the user element 12 and the remote party 16. As illustrated, the signaling portion of the local access leg remains anchored in the CCF 30; however, the signaling portion of the local access leg extends from the user element 12 to the CCF 30 through the 2G/3G PS access cell 34, a signaling gateway service node (SGSN) 36, a System Architecture Evolution (SAE) gateway 38, the CSCF 28, and the CCF 30. The signaling portion of the remote access leg does not change. For the purposes of the present invention, the SAE gateway 38 may include the functionalities of both a Packet Data Network Gateway (PDN GW) and Serving GW, as defined in 3GPP TS 23.401 v0.5.1. The SGSN 36 is the packet-based corollary of the MSC 22, and facilitates both signaling and bearer paths. Similarly, the SAE gateway 38 provides support for both signaling and bearer paths. The SAE gateway 38 may provide the requisite translations between the PS domain and the IMS 18 for both signaling and bearer paths. The bearer path tracks the signaling path through the PS domain from the user element 12 to the SAE gateway 38. As such, the PS bearer path between the user element 12 and the remote party 16 extends through the 2G/3G PS access cell 34, the SGSN 36, the SAE gateway 38, and on to the remote party 16.

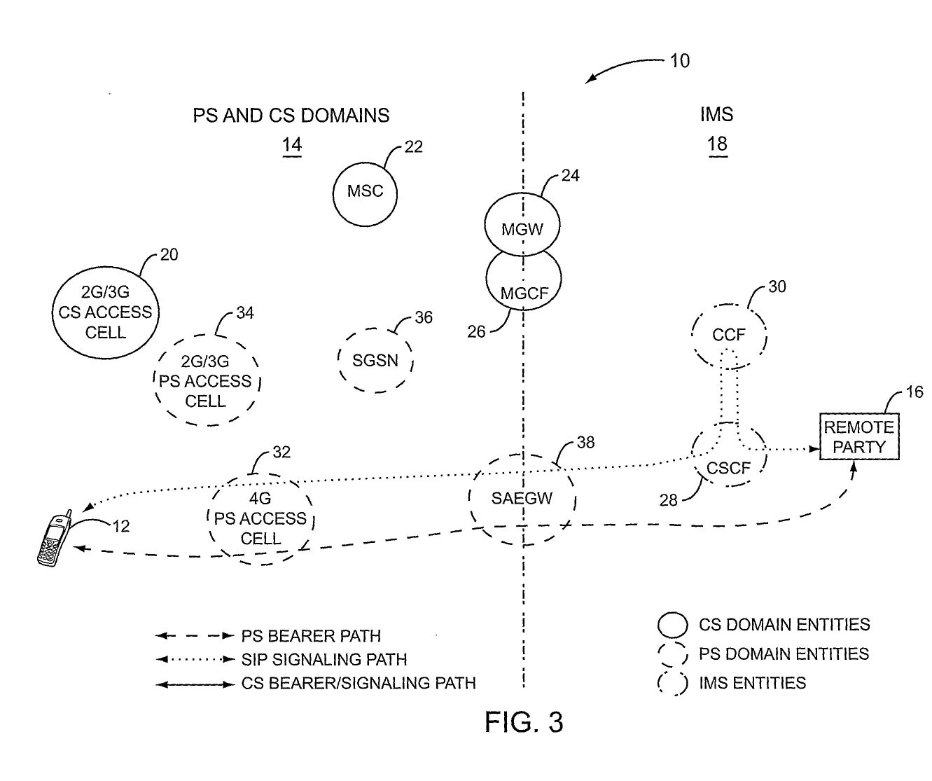

As soon as the transitional signaling and bearer paths are established between the user element 12 and the remote party 16 as illustrated in FIG. 2, the local access leg is transitioned to the 4G PS access cell 32 to complete the transition from the 2G/3G CS access cell 20 to the 4G PS access cell 32, as shown in FIG. 3. In this embodiment, assume the 4G PS access cell 32 can facilitate a PS signaling and bearer path directly or indirectly with the SAE gateway 38. As such, the signaling and bearer portions of the communication session through the IMS 18 remain the same as those for the transitional step; however, the signaling portion of the local access leg extends from the user element 12 to the CCF 30 through the 4G PS access cell 32, the SAE gateway 38, and the CSCF 28. The bearer path for the communication session extends from the user element 12 to the remote party 16 through the 4G PS access cell 32 and the SAE gateway 38. From the above, transitions from 2G or 3G CS access cells to 4G PS access cells may be facilitated through 2G or 3G PS access cells, which act as transitional cells between a serving cell and a target cell.

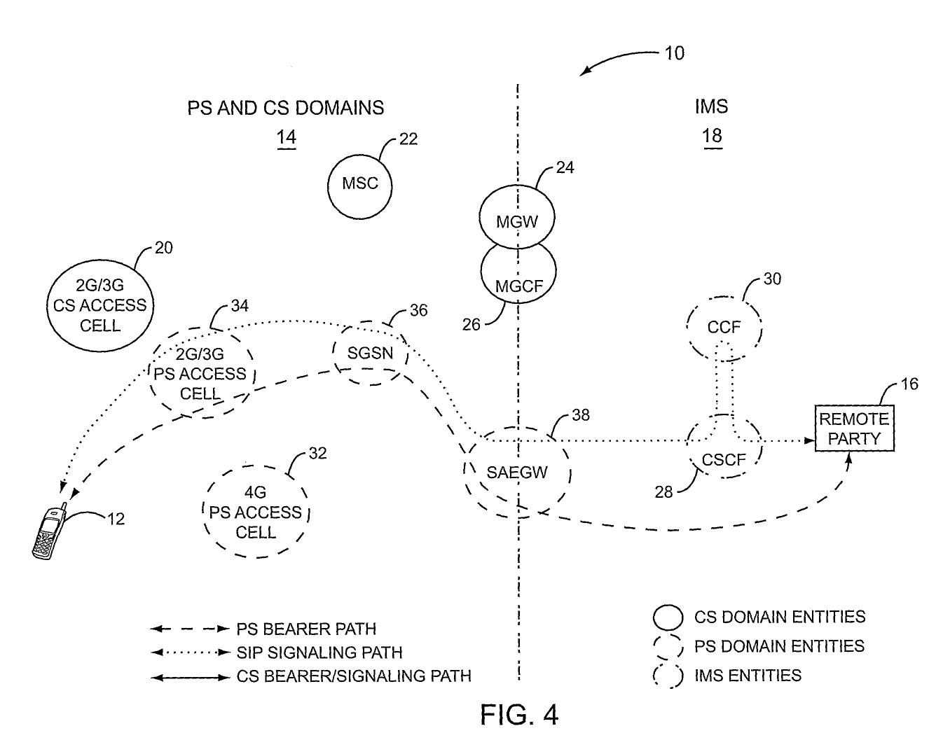

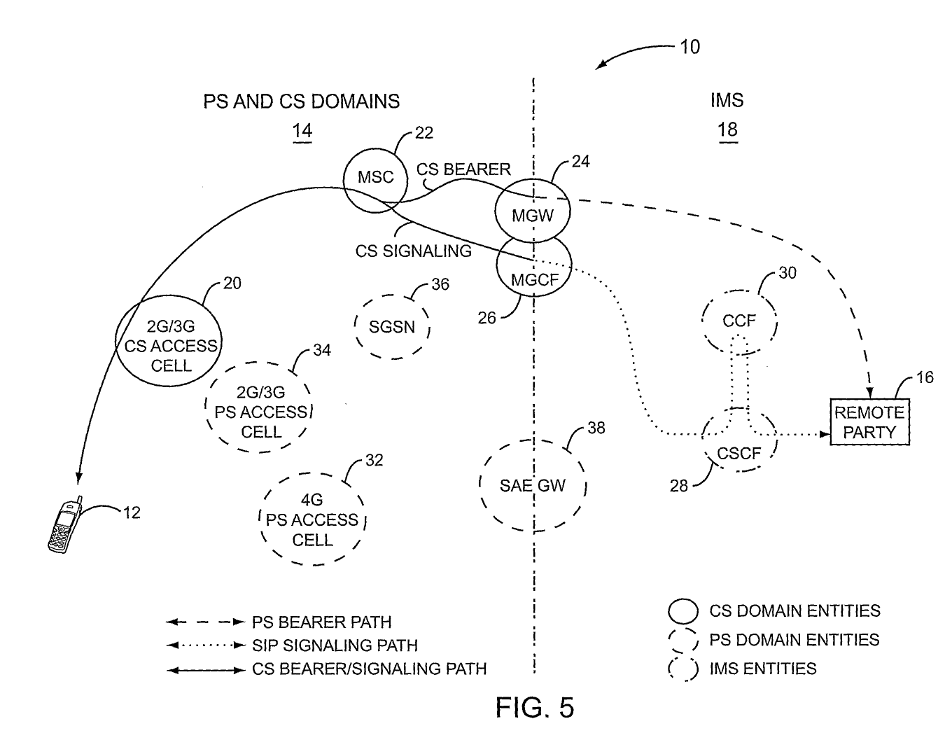

Similar transitions may take place from 4G PS access cells to 2G or 3G CS access cells through 2G or 3G PS access cells that act as transitional cells. Using FIG. 3 as a reference point, assume a 4G PS access cell 32 is a serving cell for the user element 12. To transition from the 4G PS access cell 32 to the 2G/3G CS access cell 20, the local access leg is initially transitioned from the 4G PS access cell 32 to the 2G/3G PS access cell 34, which acts as a transitional cell for transitions from the 4G PS access cell 32 to the 2G/3G CS access cell 20, as shown in FIG. 4. Once the local access leg has been transitioned from the 4G PS access cell 32 to the 2G/3G PS access cell 34, the local access signaling leg is transitioned to the 2G/3G CS access cell 20, as illustrated in FIG. 5. Notably, the details of the signaling and bearer paths of FIGS. 4 and 5 correspond to those of FIGS. 2 and 1, respectively. As such, the transitions from one access cell to another may require changes in portions of the signaling and bearer paths for the local and perhaps remote signaling legs.

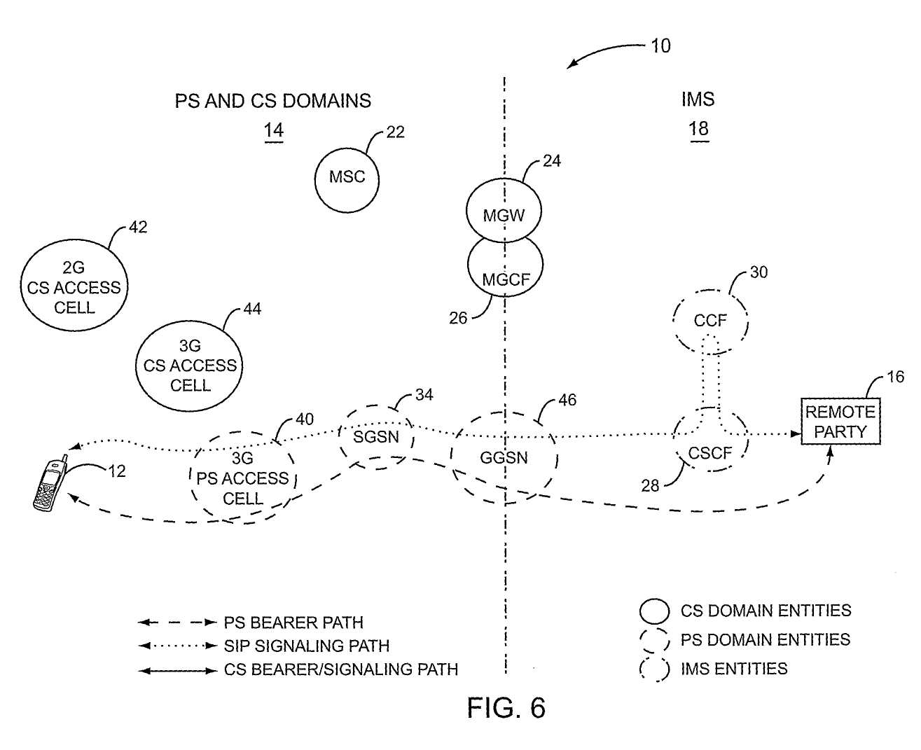

With reference to FIGS. 6-8, a scenario is depicted for transitioning the local access leg of a user element 12 from a 3G PS access cell 40 to a 2G CS access cell 42 through a 3G CS access cell 44, which acts as a transitional cell for the transition. With particular reference to FIG. 6, assume that a packet bearer path is established between the user element 12 and the remote party 16 through the 3G PS access cell 40, an associated SGSN 34, and a Gateway GPRS Support Node (GGSN) 46. The GGSN 46 provides a similar functionality to the SAE gateway 38 of the above embodiments, in that it provides the requisite translations between packet communications extending toward the user element 12 and the remote party 16, respectively. The signaling portion of the local access leg also extends through the 3G PS access cell 40, SGSN 34, and the GGSN 46. From the GGSN 46, the signaling portion of the local access leg will extend to the CCF 30 through the CSCF 28. Again, the CCF 30 will anchor the signaling portion of the local access leg and the remote access leg, which extends from the CCF 30 to the remote party 16 through the CSCF 28.

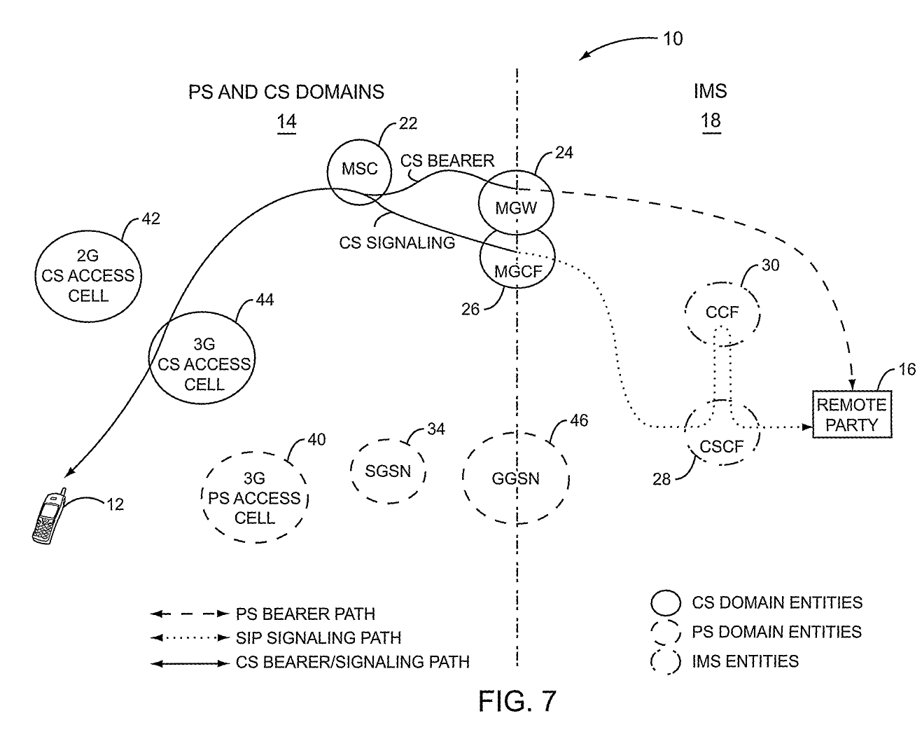

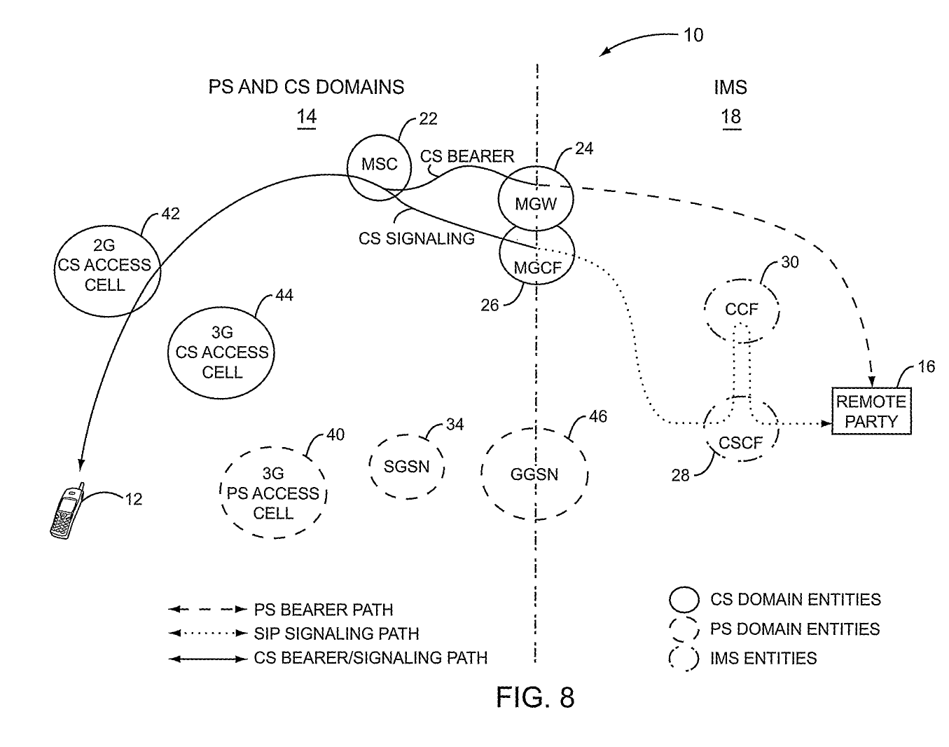

For the transition from the 3G PS access cell 40 to the 2G CS access cell 42, an initial transition to the 3G CS access cell 44 is provided as illustrated in FIG. 7. In this example, the CS bearer and signaling paths extend from the user element 12 to the MSC 22 through the 3G CS access cell 44. At the MSC 22, the CS bearer path extends to the media gateway 24 and the CS signaling path extends to the MGCF 26. The remaining portion of the bearer path is provided between the media gateway 24 and the remote party 16 in a packet domain, wherein the remaining portion of the signaling path for the local access leg extends from the MGCF 26 to the CCF 30 through the CSCF 28. Once the transition from the 3G PS access cell 40 to the 3G CS access cell 44 is complete, the local access leg is transitioned from the 3G CS access cell 44 to the 2G CS access cell 42, as illustrated in FIG. 8. Notably, the only change in the signaling and bearer paths is that the signaling and bearer paths extend between the user element 12 and the MSC 22 through the 2G CS access cell 42 instead of the 3G CS access cell 44. With the present invention, these transitions may take place while maintaining complete continuity of the communication session. In this example, the first transition effects a change from the PS domain to the CS domain within a given (third) generation, while the second transition effects a change in generations within the CS domain.

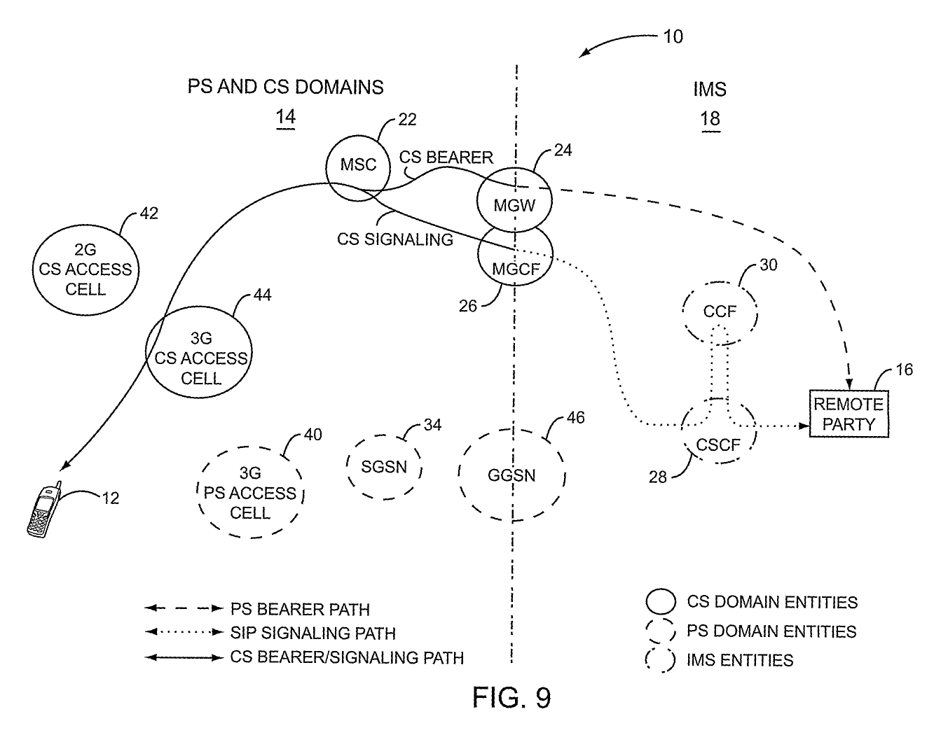

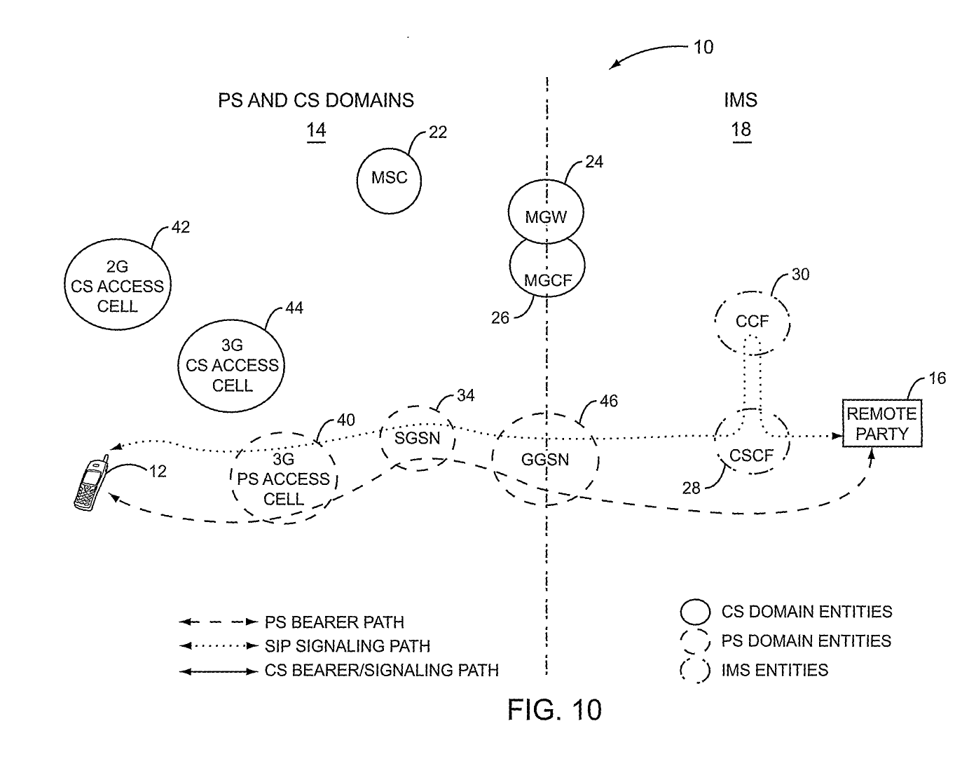

The present invention also supports transitions in the opposite direction. In other words, using FIG. 8 as a reference point, the local access leg may be transitioned from the 2G CS access cell 42 to the 3G PS access cell 40 via the 3G CS access cell 44. Accordingly, the first transition of the local access leg will be from the 2G CS access cell 42 to the 3G CS access cell 44, as illustrated in FIG. 9. Once this transition is complete, a transition of the local access leg is provided from the 3G CS access cell 44 to the 3G PS access cell 40, as illustrated in FIG. 10. The signaling and bearer paths in FIGS. 9 and 10 are the same as those described in association with FIGS. 7 and 6, respectively.

The above scenarios are merely examples to help understand the breadth of the present invention. In general, the present invention provides for the transitioning of the local access leg of a communication session for a user element 12 from a serving access network of any generation to a target access network of another generation, wherein one access network is in the PS domain and the other is in the CS domain. The transition of the local access leg for the user element 12 between the first access network and the second access network is provided using an intermediate transition employing a transitional cell. The local access leg is first transferred to the transitional cell from the serving access network, and is then immediately transferred to the target cell of the target access network while maintaining continuity of the communication sessions across both transfers. In many instances, the transitions are initiated by the user element 12 in light of a need for a certain type of service, or more likely based on a need to change from one cell to another in light of prevailing channel conditions.

Preferably, a radio layer handover is employed for transitions from one cell to another within a given domain. These transitions may be between cells of the same or different generations. The user element 12 may also request application layer handovers, perhaps in association with the CCF 30, to facilitate transitions from one type of domain to another. As such, application layer handovers are used primarily to facilitate transitions from the CS domain to the PS domain, as well as from the PS domain to the CS domain. These transitions are often within a given generation. Those skilled in the art will recognize numerous ways to facilitate these transitions in light of the teachings provided herein.

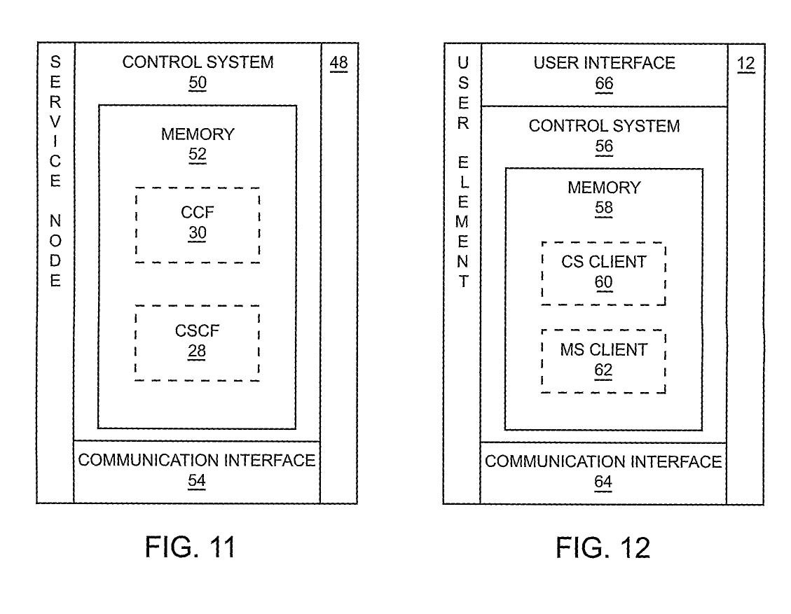

With reference to FIG. 11, a service node 48 is provided according to one embodiment of the present invention. The service node 48 may reside in the IMS 18, and includes a control system 50 and associated memory 52 to provide the functionality the CCF 30 or the CSCF 28. The control system 50 will also be associated with a communication interface 54 to facilitate communications with any entity affiliated with the IMS 18 or appropriately associated networks.

With reference to FIG. 12, a block representation of a user element 12 is provided. The user element 12 may include a control system 56 having sufficient memory 58 to support operation of a CS client 60, which facilitates CS based communications and signaling, and an MS client 62, which facilitates PS based communications and signaling. The control system 56 will cooperate closely with a communication interface 64 to allow the CS client 60 and the MS client 62 to facilitate communications, as described above. The control system 56 may also be associated with a user interface 66, which will facilitate interaction with a user. The user interface 66 may include a microphone and speaker to facilitate voice communications with the user, as well as a keypad and display to allow the user to input and view information.

Those skilled in the art will recognize improvements and modifications to the preferred embodiments of the present invention. All such improvements and modifications are considered within the scope of the concepts disclosed herein and the claims that follow.

What is claimed is:

1. A method for transitioning between cells in a cellular communications environment comprising:
establishing a communication session between a user element and a remote party wherein a local access leg for the user element is provided via a serving cell;
determining a need to transition the local access leg from the serving cell of one generation to a target cell of another generation, wherein the serving cell is in a first domain selected from one of a packet subsystem domain and a circuit-switched subsystem and the target cell is in a second domain selected from another of the packet subsystem domain and the circuit-switched subsystem;
transferring the local access leg from the serving cell to a transitional cell; and
transferring the local access leg from the transitional cell to the target cell.

2. The method of claim 1 wherein the transitional cell is in the first domain.

3. The method of claim 2 wherein the transitional cell is of the same generation as the target cell.

4. The method of claim 1 wherein the transitional cell is of the same generation as the target cell.

5. The method of claim 1 wherein the transitional cell is in the second domain.

6. The method of claim 5 wherein the transitional cell is of the same generation as the serving cell.

7. The method of claim 1 wherein the transitional cell is of the same generation as the serving cell.

8. The method of claim 1 wherein a call signaling portion of the local access leg is anchored in a function of the multimedia subsystem, and a call signaling portion of a remote access leg is anchored at the function.

9. The method of claim 1 wherein continuity of the communication session is maintained as the local access leg is transferred from the serving cell through the transitional cell to the target cell, such that the communication session is not interrupted.

10. The method of claim 1 wherein the local access leg is immediately transferred from the transitional cell to the target cell after the local access leg is transferred from the serving cell to the transitional cell.

11. The method of claim 1 wherein the serving cell is in the circuit-switched subsystem of a second generation (2G) wireless access network and the target cell is in the packet subsystem of a fourth generation (4G) wireless access network.

12. The method of claim 11 wherein the transitional cell is in the packet subsystem of the 2G wireless access network.

13. The method of claim 1 wherein the serving cell is in the circuit-switched subsystem of a third generation (3G) wireless access network and the target cell is in the packet subsystem of a fourth generation (4G) wireless access network.

14. The method of claim 13 wherein the transitional cell is in the packet subsystem of the 3G wireless access network.

15. The method of claim 1 wherein the target cell is in the circuit-switched subsystem of a second generation (2G) wireless access network and the serving cell is in the packet subsystem of a fourth generation (4G) wireless access network.

16. The method of claim 15 wherein the transitional cell is in the packet subsystem of the 2G wireless access network.

17. The method of claim 1 wherein the target cell is in the circuit-switched subsystem of a third generation (3G) wireless access network and the serving cell is in the packet subsystem of a fourth generation (4G) wireless access network.

18. The method of claim 17 wherein the transitional cell is in the packet subsystem of the 3G wireless access network.

19. The method of claim 1 wherein the target cell is in the circuit-switched subsystem of a second generation (2G) wireless access network and the serving cell is in the packet subsystem of a third generation (3G) wireless access network.

20. The method of claim 19 wherein the transitional cell is in the circuit-switched subsystem of the 3G wireless access network.

21. The method of claim 1 wherein the serving cell is in the circuit-switched subsystem of a second generation (2G) wireless access network and the target cell is in the packet subsystem of a third generation (3G) wireless access network.

22. The method of claim 21 wherein the transitional cell is in the circuit-switched subsystem of the 3G wireless access network.

23. The method of claim 1 wherein radio link handovers are employed to transfer between the transitional cell and one of the serving cell or the target cell that is in a given type of domain.

24. The method of claim 1 wherein application layer handovers are employed to transfer between the transitional cell and one of the serving cell or the target cell in different types of domains.

25. The method of claim 1 wherein a transition from the serving cell to the target cell is initiated by the user element.
